(19) United States
(12) Patent Application Publication
(10) Pub. No.: US 2023/0419932 A1
(43) Pub. Date: Dec. 28, 2023

(54) INFORMATION PROCESSING DEVICE AND CONTROL METHOD THEREOF

(71) Applicant: Yamaha Corporation, Hamamatsu (JP)

(72) Inventors: Kouhei SUMI, Hamamatsu (JP); Takahiro ASANO, Hamamatsu (JP); Ikumi OSAKI, Hamamatsu (JP)

(21) Appl. No.: 18/460,461

(22) Filed: Sep. 1, 2023

Related U.S. Application Data
(63) Continuation of application No. PCT/JP22/06589, filed on Feb. 18, 2022.

(30) Foreign Application Priority Data
Mar. 4, 2021 (JP) 2021-034735

(51) Int. Cl. G10H 1/14; G10H 5/00; G10H 1/00

(52) U.S. Cl. CPC G10H 1/14; G10H 5/005; G10H 1/0008; G10H 2220/116; G10H 2210/195

(57) ABSTRACT

An information processing device includes at least one processor configured to execute a plurality of modules including an input module into which natural language that includes an adjective is configured to be input by a user, and a timbre estimation module configured to output timbre data based on the natural language input by the user, by using a trained model configured to output the timbre data from the adjective.

### CROSS-REFERENCE TO RELATED APPLICATIONS

This application is a continuation application of International Application No. PCT/JP2022/006589, filed on Feb. 18, 2022, which claims priority to Japanese Patent Application No. 2021-034735 filed in Japan on Mar. 4, 2021. The entire disclosures of International Application No. PCT/JP2022/006589 and Japanese Patent Application No. 2021-034735 are hereby incorporated herein by reference.

### BACKGROUND

### Technological Field

This disclosure relates to an information processing device for adjusting timbre that is output based on timbre data and its control method.

### Background Information

Synthesizers that can output a timbre that is adjusted using timbre data composed of waveform data and effect parameters are known from the prior art.

For example, Japanese Laid-Open Patent Application No. 2007-156109 discloses an apparatus for musical performance that outputs sound with a pitch and timbre that correspond to the coordinate position of an input means that comes in contact with a display unit that performs a two-axial display of pitch and timbre.

Also, for example, Japanese Laid-Open Patent Application No. 2006-30414 discloses a timbre setting system that can automatically set a timbre that matches the mental state of a user, such as a mood and feeling, based upon an actual performance of the user.

### SUMMARY

However, even if the technologies of Japanese Laid-Open Patent Application No. 2007-156109 and Japanese Laid-Open Patent Application No. 2006-30414 are used, it is difficult for a beginner to operate the numerous buttons and knobs found on conventional synthesizers to locate waveform data for the types of musical instruments that the beginner wishes to use in a performance or to adjust timbre using effect parameters.

In view of this circumstance, an object of the present disclosure is to provide an information processing device with which even a beginner can easily adjust the timbre that is output and its control method.

In order to realize the object described above, an information processing device according to one aspect of the present disclosure comprises at least one processor configured to execute a plurality of modules including an input module into which natural language including an adjective is configured to be input by a user, and a timbre estimation module configured to output timbre data based on the natural language input by the user, by using a trained model configured to output the timbre data from the adjective.

Further, a control method, realized by a computer in accordance with one aspect of the present disclosure, comprises acquiring natural language that includes an adjective and us input by a user, and outputting timbre data based on the natural language input by the user by using a trained model configured to output the timbre data from the adjective.

By the present disclosure, even a beginner can easily adjust the timbre that is output.

### BRIEF DESCRIPTION OF THE DRAWINGS

FIG. 1 is a block diagram showing the hardware configuration of the information processing device according to an embodiment of the present disclosure.

FIG. 2 is a block diagram showing the software configuration of the information processing device.

FIG. 3 is a diagram showing the mapping of each effect parameter that is included in collected training data onto latent space.

FIG. 4 is a flowchart showing the training process of the learning model in the embodiment of the present disclosure.

FIG. 5 is a flowchart showing the estimation process of the timbre data in the embodiment of the present disclosure.

FIG. 6 is a diagram showing an example of a UI of the input and output units of FIG. 2, as displayed on the display unit in FIG. 1.

### DETAILED DESCRIPTION OF THE EMBODIMENTS

Embodiments of the present disclosure will be described in detail below with reference to the appended drawings. The embodiments described below are merely examples of configurations that can realize the present disclosure. Each of the embodiments described below can be appropriately modified or changed depending on various conditions and the configuration of the device to which the present disclosure is applied. Further, not all of the combinations of the elements included in the following embodiments are essential for the realization of the present disclosure, and some of the elements can be omitted as deemed appropriate. The scope of the present disclosure is therefore not limited by the configurations described in the following embodiments. Configurations that combine multiple configurations described in the embodiment can also be adopted as long as they are not mutually contradictory.

An information processing device 100 according to the present embodiment is realized by a synthesizer, but no limitation is thereby imposed. For example, the information processing device 100 can be an information processing device (computer), such as a personal computer or a server, that transmits timbre data to be set to an external synthesizer.

Here, timbre data in the present embodiment are data including waveform data of various types of musical instruments such as piano, organ, guitar, etc., and/or an effect parameter(s) such as chorus, reverb, distortion, etc.

In brief, the information processing device 100 in the present embodiment sets timbre data candidates used for adjusting timbre based on natural language input by a user when the user adjusts the timbre in order to perform with the information processing device 100, and displays each candidate in a list with sample timbres that can be played back. When the user then selects from among the candidates displayed in a list, the candidate whose played-back sample timbre the user wishes to use in the performance, the information processing device 100 adjusts the timbre so that the sample timbre is the timbre to be used when the user performs with the information processing device 100.

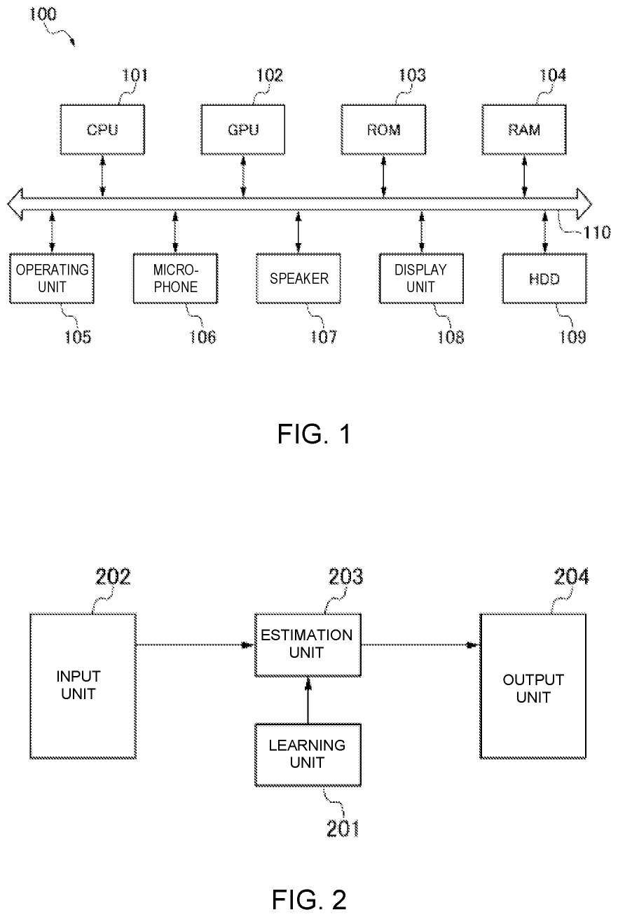

FIG. 1 is a block diagram showing the hardware configuration of the information processing device 100 according to the embodiment of the present disclosure.

As shown in FIG. 1, the information processing device 100 of the present embodiment includes a CPU (Central Processing Unit) 101, a GPU (Graphics Processing Unit) 102, a ROM (Read Only Memory) 103, RAM (Random Access Memory) 104, an operating unit 105, a microphone 106, a speaker 107, a display unit 108, and an HDD 109, which are interconnected via a bus 110. Although not shown in FIG. 1, the information processing device 100 also includes a keyboard that can be played by the user.

The CPU 101 is one or more processors that control each part of the information processing device 100 in accordance with a program stored in the ROM 103, for example, using RAM 104 as working memory. The CPU 101 is one example of at least one processor included in an electronic controller of the information processing device 100. Here, the term “electronic controller” as used herein refers to hardware, and does not include a human. The electronic controller can be configured to comprise, instead of the CPU 101 or in addition to the CPU 101, an MPU (Microprocessing Unit), a GPU (Graphics Processing Unit), an ASIC (Application Specific Integrated Circuit), an FPGA (Field Programmable Gate Array), a DSP (Digital Signal Processor), and a general-purpose computer. Moreover, the electronic controller can include a plurality of CPUs.

As the GPU 102 can compute more efficiently by parallel processing of data, the training process using a learning model is carried out by the GPU 102, as described further below. The GPU 102 is one example of an additional processor included in the electronic controller of the information processing device 100.

The ROM 13 is a non-volatile memory, for example, and stores various program. The RAM 104 is a volatile memory and is used as temporary storage areas for the CPU 101, such as main memory, working area, etc.

The microphone 106 converts collected voice into electronic signals (voice data) and supplies the electronic signals to the CPU 101. For example, the microphone 106 collects voice consisting of natural language spoken by the user toward the microphone 106 and supplies the converted voice data to the CPU 101.

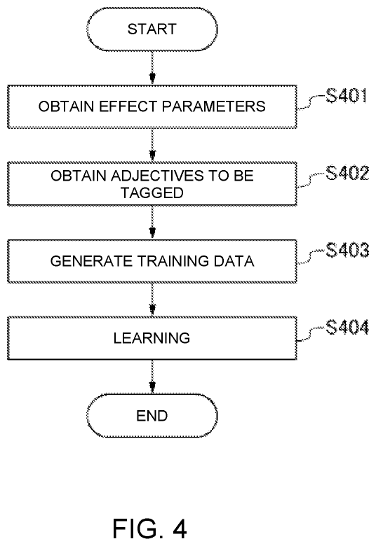

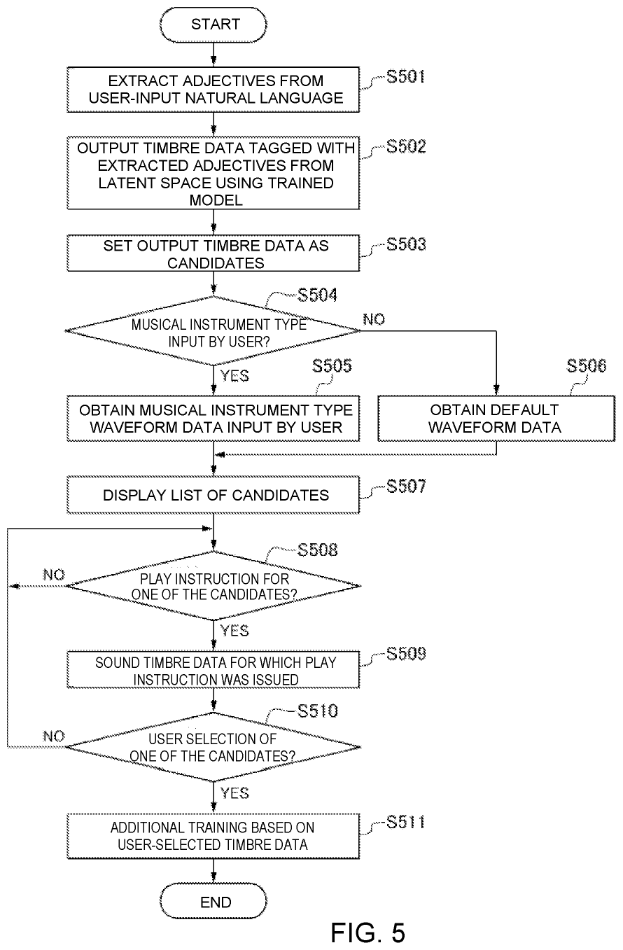

The speaker 107 produces the adjusted timbre during the performance using the information processing device 100, during execution of Step S402 of FIG. 4, described further below, during execution of Step S509 of FIG. 5, described further below, and so on.

The HDD 109 is a non-volatile memory in which timbre and other data, various programs for the operation of the CPU 101, etc., are stored in prescribed areas. The HDD 109 can be any non-volatile memory in which the data and programs described above can be stored, and can be other memory such as flash memory, for example.

The operating unit (user operable input) 105 and the display unit (display) 108 are integrally configured as a touch panel display that receives user operations on the information processing device 100 and that displays various information. However, the operating unit 105 and the display unit 108 can be independently configured as user interfaces; for example, the operating unit 105 can be configured as a keyboard and a mouse, and the display unit 108 can be configured as a display such as a liquid-crystal display or an organic electroluminescent display.

The bus 110 is a signal transmission path that interconnects the hardware elements of the information processing device 100.

FIG. 2 is a block diagram showing a functional configuration of the information processing device 100.

In FIG. 2, the information processing device 100 includes a learning unit 201, an input unit 202, an estimation unit 203, and an output unit 204.

In the present embodiment, the input unit (input module) 202 and the output unit (module 204) of the information processing device 100 can be realized and executed by the CPU 101. Moreover, the learning unit (learning module) 201 and the estimation unit (timbre estimation module) 203 can be realized and executed by the GPU 102 or a corporation of the CPU 101 and the GPU 102.

However, the learning unit 201, the input unit 202, the estimation unit 203, and the output unit 204 can be realized and executed by one single processor, such as either one of the CPU 101 or the GPU 102.

The input unit (input module) 202 is a function that is executed by CPU 101 and that outputs one or more adjectives input by the user to the estimation unit 203.

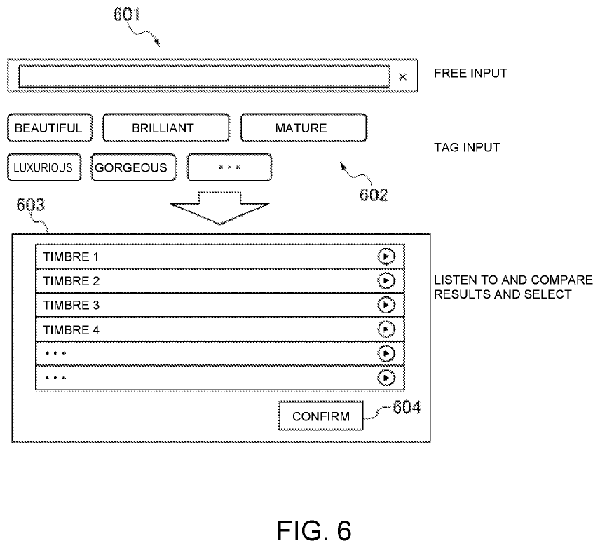

Specifically, the input unit 202 displays an OF 601 (FIG. 6) on the display unit 108 and acquires natural language that has been input as text to I/F 601 by the user using the operating unit 105. The input unit 202 then performs a morphological analysis of the acquired natural language, extracts one or more adjectives input by the user, and outputs the extracted one or more adjectives to the estimation unit 203.

The input unit 202 is not limited to the present embodiment as long as one or more adjectives input by the user can be acquired. For example, one or more adjectives input by the user can be acquired based on the natural language spoken by the user and collected by the microphone 106, or an OF 602 (FIG. 6) that includes tags for a plurality of adjectives can be displayed on the display unit 108, and the adjectives of the tags selected by the user via the operating unit 105 can be acquired as the one or more adjectives input by the user.

Details of the processing performed by the input unit 202 will be described further below with reference to FIG. 5.

The learning unit (learning module) 201 is a function performed by the GPU 102, which comprises a learning model consisting of a CVAE (conditional variational auto encoder), a type of a neural network. The GPU 102 trains the learning model that constitutes the learning unit 201 by supervised learning using training data including one or more effect parameters and one or more adjectives tagged to them, and outputs the parameters of a decoder for the generated trained model, described further below, to the estimation unit 203.

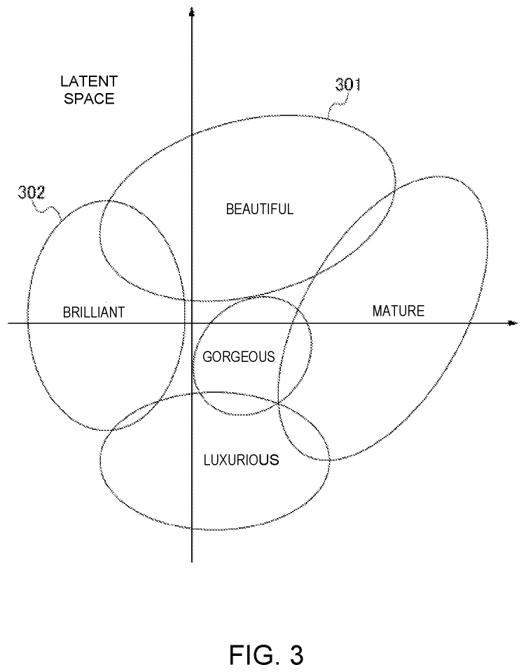

The learning model that constitutes the learning unit 201 includes an encoder and a decoder. The encoder is a neural network that extracts latent variables z tagged with adjectives (label y) in latent space from training data when effect parameters (input data x) tagged with adjectives (label y) are input as training data. The decoder is a neural network that reconstructs effect parameters (output data x′) tagged with adjectives (label y) when latent variables z tagged with adjectives (label y) are input. GPU 102 compares the input data x and the output data x′ and adjusts the parameters of the encoder and the decoder that constitute the learning unit 201. For each label y, the parameters of the encoder are adjusted so that clusters of latent variables z are formed in the latent space shown in FIG. 3. By repeating this process and optimizing the parameters of the learning model that constitutes the learning unit 201, GPU 102 trains the learning model and generates a trained model. Details of the learning model training process performed by GPU 102 will be described further below with reference to FIG. 4.

The estimation unit (timbre estimation module) 203 is a neural network identical to the decoder of the trained model generated in the learning unit 201 (hereinafter referred to simply as decoder) and is a function executed by GPU 102.

When a parameter is output from the learning unit 201 to the estimation unit 203, GPU 102 updates the parameters of the decoder constituting the estimation unit 203 with the parameter.

Further, when an adjective input by the user is output from the input unit 202 to the estimation unit 203, the GPU 102 acquires the latent variable z tagged with the adjective from the latent variables z in the latent space shown in FIG. 3 and inputs the adjective into the decoder constituting the estimation unit 203, thereby reconstructing (estimating) the effect parameter (timbre data) tagged with the adjective. The GPU 102 then outputs the reconstructed effect parameter to the output unit 204. Details of the estimation process of the timbre data carried out by the GPU 102 will be described further below with reference to FIG. 5.

The neural network used in the learning unit 201 and the estimation unit 203 is not particularly limited and can be, for example, a DNN (Deep Neural Network), RNN (Recurrent Neural Network)/LSTM (Long Short-Term Memory), Recurrent Neural Network, or a CNN (Convolutional Neural Network). Other models, such as an HMM (hidden Markov model) or an SVM (support vector machine) can be used instead of a neural network.

Although the learning unit 201 comprises only of a CVAE to perform supervised learning, the configuration can also include a VAE (variational auto encoder) and GANs (Generative Adversarial networks). In this case, in the learning unit 201, semi-supervised learning is performed by combining unsupervised learning by a VAE or a GAN, that is, learning using clustering, in which effect parameters not tagged with adjectives are used as training data, with supervised learning by a CVAE.

Further, the learning unit 201 and the estimation unit 203 can be a single device (system).

Further, although the learning unit 201 and the estimation unit 203 can be executed by the GPU 102, which in the present embodiment is a single processor, the GPU 102 can include a plurality of processors to perform distributed processing. Further, in addition to its execution by the GPU 102, the function can be performed in cooperation with the CPU 101.

The output unit (presentation module) 204 is a function that is executed by CPU 101 and that displays (presents) a list of the plurality of effect parameters output from the estimation unit 203 as candidates for effect parameters to be used for timbre adjustment when the user performs using the information processing device 100.

Specifically, the output unit 204 displays on the display unit 108 an I/F 603 (FIG. 6) that includes a plurality of tabs associated with each of the candidate effect parameters. As shown in FIG. 6, each tab of I/F 603 has a play button associated with a sample sound when the timbre is adjusted by each effect parameter. When any one of the play buttons on I/F 603 is then pressed by the user, the output unit 204 places the tab in which the play button is provided in the user-selected state and plays the sample timbre associated with the play button. Once the desired sample timbre is played back by the user's pressing of the play buttons displayed on I/F 603, the user presses a confirm button 604. When the confirm button 604 is pressed, the output unit 204 makes the determination to use the effect parameter associated with the tab currently selected by the user to adjust the timbre of the information processing device 100.

Details of the process carried out by the output unit 204 will be described further below with reference to FIG. 5.

FIG. 3 is a diagram showing the mapping of each effect parameter that is included in collected training data onto the latent space.

When the trained model is generated in the learning unit 201 by GPU 102, the effect parameters (input data x) are mapped as latent variables z onto the latent space. A large number of these latent variables z are included in one of the clusters formed for each label y. In the present embodiment, as shown in FIG. 3, cluster 301 of the adjective “beautiful,” which is one of the labels y tagged to the input data x, cluster 302 of the adjective “brilliant,” which is also one of the labels y, and the like, are formed in the latent space.

In the present embodiment, a case in which only effect parameters are input as the input data x to the learning unit 201 is described, but no limitation is imposed thereby as long as the data are timbre data. For example, timbre data composed only of waveform data, of a combination of waveform data and effect parameters, or a timbre dataset containing a plurality of timbre data can be the input data x to the learning unit 201.

FIG. 4 is a flowchart showing the training process of the learning model of the present embodiment.

This process is executed by CPU 101 reading a program stored in the ROM 103 and using RAM 104 as working memory.

First, in Step S401, CPU 101 acquires effect parameters from HDD 109. Effect parameters can be obtained from the outside via a communication unit not shown in FIG. 1.

In Step S402, CPU 101 acquires adjectives to be tagged for each of the effect parameters collected in Step S401.

Here, the adjectives to be tagged are specifically acquired as follows.

First, CPU 101 uses each of the collected effect parameters, adjusts the timbre of the piano waveform data, which are the default waveform data, and causes the speaker 107 to produce the timbre and the display unit 108 to display OF 601 (FIG. 6).

Thereafter, when it is detected that an adjective, brought to mind by the timbre produced by the speaker 107, has been input to OF 601 as text by the user via the operating unit 105, CPU 101 acquires the adjective input as text as an adjective to be tagged. Here, one or more adjectives can be acquired.

Since the adjectives to be tagged are obtained in the above-described manner, the correlation between the timbre data contained in the training data and the adjectives tagged thereto can be inferred in view of the common technical knowledge at the time of filing.

In Step S403, CPU 101 tags the adjectives obtained in Step S402 to the effect parameters obtained in Step S401, thereby generating training data. The dataset consisting of these effect parameters and adjectives to be tagged thereto can be obtained by crowdsourcing.

In Step S404, CPU 101 inputs the training data generated in Step S403 to the learning unit 201, thereby causing GPU 102 to train the learning model constituting the learning unit 201 and generate a trained model. GPU 102 outputs the parameters of the decoder of the trained model from the learning unit 201 to the estimation unit 203, updates the parameters of the decoder constituting the estimation unit 203, and then terminates the process.

In the present embodiment, the timbre produced by the speaker 107 in Step S402 is obtained by adjusting the timbre of the piano waveform data, but the timbre of the waveform data of each of a plurality of different types of musical instruments can be adjusted. In this case, an adjective to be tagged to the same effect parameter for each type of musical instrument is obtained in Step S402. Further, in Step S404, a trained model is generated for each type of musical instrument.

A timbre data estimation process of the present embodiment, which is executed after the process of FIG. 4, will now be described with reference to FIG. 5.

FIG. 5 is a flowchart showing the timbre data estimation process of the present embodiment.

This process is executed by CPU 101 reading a program stored in the ROM 103 and using RAM 104 as working memory.

First, in Step S501, CPU 101 causes the display unit 108 to display OF 601 and obtains the natural language that has been input to OF 601 as text by the user via the operating unit 105. An arbitrarily selected morphological analysis of the acquired natural language is then performed to extract adjectives input by the user.

For example, if the natural language “beautiful piano sound” is input to OF 601 as text, three words, “beautiful,” “piano,” and “sound,” are obtained by morphological analysis of the natural language input as text, from which the word “beautiful” is extracted as an adjective input by the user.

Further, if the natural language “brilliant and beautiful piano sound” is input to OF 601 as text, two words, “brilliant” and “beautiful,” are extracted as adjectives input by the user.

Note that Step S501 is not limited to the method of the present embodiment as long as adjectives input by the user can be obtained. For example, instead of displaying OF 601, OF 602 that displays a plurality of adjectives obtained in the process of Step S402 as user-selectable tags can be displayed, and the adjectives displayed on the user-selected tags can be obtained as the adjectives input by the user. Further, instead of displaying OF 601, voice data that includes natural language spoken by the user into the microphone 106 can be converted into text data using any speech recognition technology, and an arbitrarily selected morphological analysis can be performed on the text data to extract the adjectives input by the user.

Next, in Step S502, CPU 101 obtains latent variables tagged with the adjectives extracted in Step S501 from the latent space and inputs the latent variables tagged with the adjectives into the decoder that constitutes the estimation unit 203. GPU 102 causes the decoder that constitutes the estimation unit 203 to output the effect parameters tagged with the adjectives. If there is a plurality of adjectives extracted in Step S501, all of the adjectives are input into the decoder that constitutes the estimation unit 203.

For example, if the adjective “beautiful” is extracted in Step S501, the estimation unit 203 outputs the effect parameters tagged with the adjective “beautiful,” reconstructed by latent variables z tagged with the adjective “beautiful” in the latent space, such as the latent variables z that form cluster 301 shown in FIG. 3.

Further, for example, if the adjectives “beautiful” and “brilliant” are extracted in Step S501, the estimation unit 203 outputs the effect parameters tagged with these two adjectives, reconstructed by latent variables z tagged with these two adjectives in the latent space, such as the latent variables z that form cluster 301 and cluster 302 shown in FIG. 3.

If a trained model is generated for each type of musical instrument in Step S404, and the musical instrument type is extracted in addition to the adjectives in Step S501, the adjectives extracted in Step S501 are input into the decoder of the extracted musical instrument type in the estimation unit 203.

In Step S503, CPU 101 sets the effect parameter candidates to be used by the user for timbre adjustment from among the plurality of effect parameters output in Step S502. In the present embodiment, parameters randomly specified from among the plurality of effect parameters output in Step S502 are set as the effect parameter candidates to be used by the user for timbre adjustment. Of the plurality of effect parameters output in Step S502, those with a likelihood that exceeds a threshold value can be set as the effect parameter candidates to be used by the user for timbre adjustment.

In Step S504, CPU 101 determines whether the user has input a musical instrument type. Specifically, if there is a musical instrument type among the words obtained by the arbitrarily selected morphological analysis in Step S501, it is determined that the user has input a musical instrument type.

For example, if the natural language “beautiful piano sound” is input to I/F 601 as text in Step S501, CPU 101 determines that the user has input the musical instrument type “piano” in Step S504.

If the user has input the musical instrument type (YES in Step S504), the process proceeds to Step S505, in which waveform data of the musical instrument type input by the user is obtained by CPU 101 from HDD 109, and then proceeds to Step S507.

In this case, CPU 101 further restricts (discards or selects) the candidates set in Step S503 according to the musical instrument type input by the user. For example, if the musical instrument type input by the user is “piano” and “distortion” is included in the set of candidates, as “distortion” is not ordinarily used for timbre adjustment, then it is excluded from the candidates.

On the other hand, if the user has not input the musical instrument type (NO in Step S504), the process proceeds to Step S506, in which waveform data of the musical instrument type “piano” set by default is obtained by CPU 101 from HDD 109, and then proceeds to Step S507. The waveform data of the musical instrument type set by default is not limited to that of the present embodiment, and can be waveform data of other musical instrument types, such as organ, guitar, etc. Further, in Step S506, CPU 101 can cause the display unit 108 to display a plurality of tags, each describing a plurality of musical instrument types, and obtain the waveform data of the musical instrument type displayed on the tag selected by the user from HDD 109.

In Step S507, CPU 101 causes the display unit 108 to display a list of the effect parameter candidates set in Step S503. More specifically, as shown in OF 603 of FIG. 6, the effect parameter candidates set in Step S503 are displayed as user-selectable tabs, such as tabs for “timbre 1,” “timbre 2,” etc. Each tab also has a play button.

In Step S508, CPU 101 determines whether there has been an instruction to play one of the effect parameter candidates set in Step S503. More specifically, it is determined whether one of the play buttons provided on the tabs of I/F 603 has been pressed. If there is an instruction to play one of the candidates (YES in Step S508), the process proceeds to Step S509.

In Step S509, CPU 101 inverts the color of the tab whose play button has been pressed (or its play button portion) in the display unit 108 to notify the user that the tab is in the user-selected state, adjusts the timbre using the effect parameter of the candidate for which the play instruction was issued and the waveform data obtained in Step S505 or S506, and causes the speaker 107 to sound (play) the adjusted timbre as a sample timbre.

In Step S510, CPU 101 determines whether the candidate for which the play instruction was issued is selected by the user as an effect parameter to be used for timbre adjustment. More specifically, if, after the sample tone is sounded by the speaker 107 in Step S509, the confirm button 604 is pressed without another play button of I/F 603 having been pressed, it is determined that the candidate for which a play instruction was issued is selected by the user as an effect parameter to be used for timbre adjustment.

That is, if there is an instruction to play one of the other candidates without the confirm button 604 having been pressed (NO in Step S510 and YES in Step S508), the processes after Step S509 are repeated. On the other hand, if the confirm button 604 is pressed without a play instruction for one of the other candidates (YES in Step S510), CPU 101 performs a timbre adjustment so that the reproduced sample timbre becomes the timbre for performance by the information processing device 100, and then proceeds to Step S511.

In Step S511, CPU 101 causes the GPU 102 to perform additional training of the trained model generated by the learning unit 201 based on the adjectives extracted in Step S501 and the effect parameters used for timbre adjustment selected by the user in Step S510. The parameters of the decoder constituting the estimation unit 203 are then updated using the parameters of the decoder portion of the trained model after the additional training, and the process is then terminated. As a result, as the user continues to make timbre adjustments using the process of FIG. 5 when the user carries out a performance with the information processing device 100, the effect parameter candidates displayed as a list on I/F 603 will become increasingly personalized.

According to the present embodiment, when the user inputs text to I/F 601 on the display unit 108 that stands for natural language that represents the timbre the user wishes to use while performing with the information processing device 100, CPU 101 sets effect parameter candidates that the user uses for timbre adjustment based on the input natural language and displays play buttons for reproducing the sample timbre of each candidate on I/F 603. The user can press a play button displayed on I/F 603 to reproduce a sample timbre, and when it is confirmed that that timbre is a timbre the user wishes to use when performing with the information processing device 100, the user simply presses the confirm button 604 to adjust the timbre the user wishes to use when carrying out a performance using the information processing device 100. That is, even if the user is a beginner who finds it difficult to operate the numerous buttons and knobs provided on a conventional synthesizer, by adjusting the effect parameters that the user wishes to use when performing with the information processing device 100, the user can easily adjust the timbre when carrying out a performance using the information processing device 100.

Further, it is possible to easily set waveform data of the musical instrument type when performing with the information processing device 100 without operating the numerous buttons and knobs provided on a conventional synthesizer.

the method of additional training carried out in Step S511 is not particularly limited. For example, the training data generated in Step S403 can be updated based on contents selected by the user using I/F 603 in the process of FIG. 5, or reinforcement learning can be conducted to reward the user selection in Step S510.

In the present embodiment, the information processing device 100 performs all the processes of FIGS. 4 and 5, but the invention is not limited to such a configuration. For example, the information processing device 100 can be connected to a mobile terminal (not shown) such as a tablet or a smartphone, or to a server (cloud) (not shown), and co-operate with these devices, that is, share processing among each device, so that processing can be performed anywhere. For example, the trained model can be generated in the cloud, and I/F 601 of FIG. 6 can be displayed on a mobile device.

Any machine learning method can be used to train the learning model of the learning unit 201 and to train additional learning models. For example, Gaussian process regression (Bayesian optimization), the policy gradient method, which is a type of policy iteration method, and genetic algorithms that mimic biological evolutionary processes, and other methods can be employed.

A storage medium for storing each control program represented by software for realizing the present disclosure can be read by each device to achieve the same effects, in which case the program code read from the storage medium realizes the novel functions of the present disclosure, so that the non-transitory, computer-readable storage medium for storing the program code constitutes the present disclosure. Further, the program code can be supplied via a transmission medium, or the like, in which case the program code itself constitutes the present disclosure. The storage medium in these cases can include, in addition to ROM, floppy disks, hard disks, optical discs, magneto-optical discs, CD-ROM, CD-R, magnetic tape, non-volatile memory cards, etc. The “non-transitory, computer-readable storage medium” includes storage media that retain programs for a set period of time, such as volatile memory (for example, DRAM (Dynamic Random Access Memory)) inside a computer system that constitutes a server or a client, when the program is transmitted via a network such as the Internet or a communication line, such as a telephone line.

By the information processing device and control method of the present disclosure, even a beginner can easily adjust the timbre to be output.

What is claimed is:

1. An information processing device comprising:
at least one processor configured to execute a plurality of modules including
an input module into which natural language that includes an adjective is configured to be input by a user, and
a timbre estimation module configured to output timbre data based on the natural language input by the user, by using a trained model configured to output the timbre data from the adjective.

2. The information processing device according to claim 1, wherein
the timbre estimation module is configured to output a plurality of pieces of the timbre data, and
the at least one processor is configured to execute the plurality of modules further including a presentation module configured to present the plurality of pieces of the timbre data to the user as timbre data candidates to be selected by the user.

3. The information processing device according to claim 2, wherein
the presentation module is configured to sound the timbre data candidates.

4. The information processing device according to claim 3, wherein
each of the timbre data candidates included at least one of waveform data, an effect parameter, or both.

5. The information processing device according to claim 4, wherein
each of the timbre data candidates is a timbre dataset including the waveform data and the effect parameter.

6. The information processing device according to claim 4, wherein
as each of the timbre data candidates includes only the effect parameter, the presentation module is configured to generate a sound by combining the effect parameter with default waveform data.

7. The information processing device according to claim 4, wherein
as each of the timbre data candidates includes only the effect parameter, and as the natural language input by the user includes a musical instrument type, the presentation module is configured to generate a sound by combining the effect parameter with waveform data of the musical instrument type.

8. The information processing device according to claim 7, wherein
the presentation module is configured to restrict the timbre data candidates in accordance with the musical instrument type.

9. The information processing device according to claim 2, wherein
the at least one processor is configured to execute the plurality of modules further including a training module configured to perform additional training of the trained model based on the adjective included in the natural language input by the user and one piece of the timbre data that is selected by the user from the timbre data candidates.

10. The information processing device according to claim 2, wherein
the timbre estimation module is configured to obtain from a latent space, latent variables tagged with the adjective included in the natural language input by the user, and input the latent variables to the trained model, thereby outputting the plurality of pieces of the timbre data.

11. A control method realized by a computer, the control method comprising:
acquiring natural language that includes an adjective and is input by a user; and
outputting timbre data based on the natural language input by the user, by using a trained model configured to output the timbre data from the adjective.

12. The control method according to claim 11, wherein
in the outputting of the timbre data, a plurality of pieces of the timbre data are output, and
the control method further comprises presenting the plurality of pieces of the timbre data to the user as timbre data candidates to be selected by the user.

13. The control method according to claim 12, wherein
the timbre data candidates are sounded in the presenting of the plurality of pieces of the timbre data.

14. The control method according to claim 13, wherein
each of the timbre data candidates includes at least one of waveform data, or an effect parameter, or both.

15. The control method according to claim 14, wherein
each of the timbre data candidates is a timbre dataset including the waveform data and the effect parameter.

16. The control method according to claim 14, wherein
as each of the timbre data candidates includes only the effect parameter, the effect parameter is combined with default waveform data to generate a sound, in the presenting of the plurality of pieces of the timbre data.

17. The control method according to claim 14, wherein
as each of the timbre data candidates includes only the effect parameter, and as the natural language input by the user includes a musical instrument type, the effect parameter is combined with waveform data of the musical instrument type to generate a sound, in the presenting of the plurality of pieces of the timbre data.

18. The control method according to claim 17, wherein
the timbre data candidates are restricted in accordance with the musical instrument type, in the presenting of the plurality of pieces of the timbre data.

19. The control method according to claim 12, further comprising
performing additional training of the trained model based on the adjective that is included in the natural language input by the user and one piece of timbre data selected by the user from among the timbre data candidates.

20. The control method according to claim 12, wherein
the outputting of the plurality of pieces of timbre data is performed by obtaining from a latent space latent variables tagged with the adjectives included in the natural language input by the user, and by inputting the latent variables to the trained model.
